(19) United States
(12) Patent Application Publication
(10) Pub. No.: US 2014/0079139 A1
(43) Pub. Date: Mar. 20, 2014

(54) MOVING IMAGE PROCESSING APPARATUS THAT PROCESSES A PLURALITY OF MOVING IMAGE DATA SETS

(71) Applicant: CASIO COMPUTER CO., LTD., Tokyo (JP)

(72) Inventors: Shohei SAKAMOTO, Tokyo (JP); Katsunori TSUTSUMI, Tokyo (JP); Hiroyoshi OGAWA, Tokyo (JP); Jun MURAKI, Tokyo (JP)

(73) Assignee: CASIO COMPUTER CO., LTD., Tokyo (JP)

(21) Appl. No.: 13/973,768

(22) Filed: Aug. 22, 2013

(30) Foreign Application Priority Data
Sep. 20, 2012 (JP) 2012-207344

(51) Int. Cl. H04N 7/26

(52) U.S. Cl. CPC H04N 19/00533; H04N 19/00484
USPC 375/240.25

(57) ABSTRACT

A moving image processing apparatus includes: a block processing unit that processes moving image data in a block unit; a switching unit that switches the moving image data processed by the block processing unit in the block unit; and a switching control unit that, according to a predetermined state of a plurality of moving image data sets that is a target for switching by the switching unit, changes an order of switching the plurality of moving image data sets by the switching unit.

This application is based on and claims the benefit of priority from Japanese Patent Application No. 2012-207344, filed on 20 Sep. 2012, the content of which is incorporated herein by reference.

### BACKGROUND OF THE INVENTION

1. Field of the Invention

The present invention relates to a moving image processing apparatus that performs predetermined processing such as replaying, recording on a plurality of moving image data sets.

2. Related Art

Conventionally, a plurality of moving image data sets has been recorded at the same time or has been decoded to replay. Although corresponding codec hardware is required in order to encode or decode a plurality of moving image data sets, there is a variety of technologies for encoding or decoding by way of single piece of codec hardware. For example, although there is technology for compensating for a lack of codec hardware by using a software codec, this technology raises another problem in that a long time is required for processing.

Japanese Unexamined Patent Application, Publication No. 2008-72336 discloses the technology of encoding or decoding by way of a single piece of codec hardware without using a software codec. This technology encodes or decodes by switching moving image data sets with a GOP (Group of Picture) as a unit.

### SUMMARY OF THE INVENTION

An aspect of the present invention is a moving image processing apparatus including: a block processing unit that processes moving image data in a block unit; a switching unit that switches the moving image data processed by the block processing unit in the block unit; and a switching control unit that, according to a predetermined state of a plurality of moving image data sets that is a target for switching by the switching unit, changes an order of switching the plurality of moving image data sets by the switching unit.

Furthermore, another aspect of the present invention is a moving image processing method of simultaneously performing predetermined processing on a plurality of moving image data sets using a block processing unit that processes moving image data in a block unit; the method comprising: switching processing of switching the moving image data processed by the block processing unit in the block unit; and switching control processing of changing, according to a predetermined state of a plurality of moving image data sets that is a target for switching in the switching processing, an order of switching the plurality of moving image data sets in the switching processing.

Furthermore, another aspect of the present invention is a non-transitory storage medium encoded with a computer-readable program that enables a computer of a moving image processing apparatus of simultaneously performing predetermined processing on a plurality of moving image data sets using a block processing unit that processes moving image data in a block unit; to execute functions as: a switching unit that switches the moving image data processed by the block processing unit in the block unit; and a switching control unit that, according to a predetermined state of a plurality of moving image data sets that is a target for switching by the switching unit, changes an order of switching the plurality of moving image data sets by the switching unit.

### BRIEF DESCRIPTION OF THE DRAWINGS

FIG. 1 is a block diagram showing a case of performing decoding processing in a moving image processing apparatus according to an embodiment of the present invention;

FIG. 2 is a schematic diagram showing a FIFO buffer area;

FIG. 3 is a flowchart showing a flow of display control processing executed by the display control unit of FIG. 1;

FIG. 4 is a flowchart showing a flow of moving image selection control processing executed by the moving image selection control unit of FIG. 1;

FIG. 5 is a flowchart showing a flow of frame rate change processing executed by the frame rate change unit of FIG. 1;

FIG. 6 is a flowchart showing another example of a flow of the moving image selection control processing executed by the moving image selection control unit of FIG. 1; and

FIG. 7 is a block diagram showing a case of performing encoding processing in the moving image processing apparatus according to one embodiment of the present invention.

### DETAILED DESCRIPTION OF THE INVENTION

In the following, embodiments of the present invention are explained with reference to the drawings.

A moving image processing apparatus according to one embodiment of the present invention performs encoding and decoding in conformity with H.264/MPEG (Moving Picture Experts Group)-4 AVC (Advanced Video Coding).

Furthermore, the moving image processing apparatus, for example, encodes a moving image photographed at the same time (photographed in synchronization) with a plurality of image capture apparatuses using one piece of codec hardware, generates a plurality of moving image data sets in which an IDR (Instantaneous Decoder Refresh) cycle and a frame rate differ from each other, and stores in a storage unit.

Furthermore, the moving image processing apparatus decodes, by way of one piece of codec hardware, a plurality of moving image data sets, of which an IDR cycle and a frame rate differ from each other, stored in the storage unit by the abovementioned encoder, and performs replay at the same time by splitting to display on a single display unit.

The moving image processing apparatus thus configured does not use a plurality of pieces of codec hardware for each encoding or each decoding.

Normally, a software codec is used in a case of performing codec on a plurality of moving image data sets by single piece of codec hardware, and it takes a long time for processing using a software codec. However, the moving image processing apparatus according to the present embodiments does not use a software codec and thus it does not take a long time for processing of replaying and recording moving image data.

Decoding processing is first described for the moving image processing apparatus thus configured.

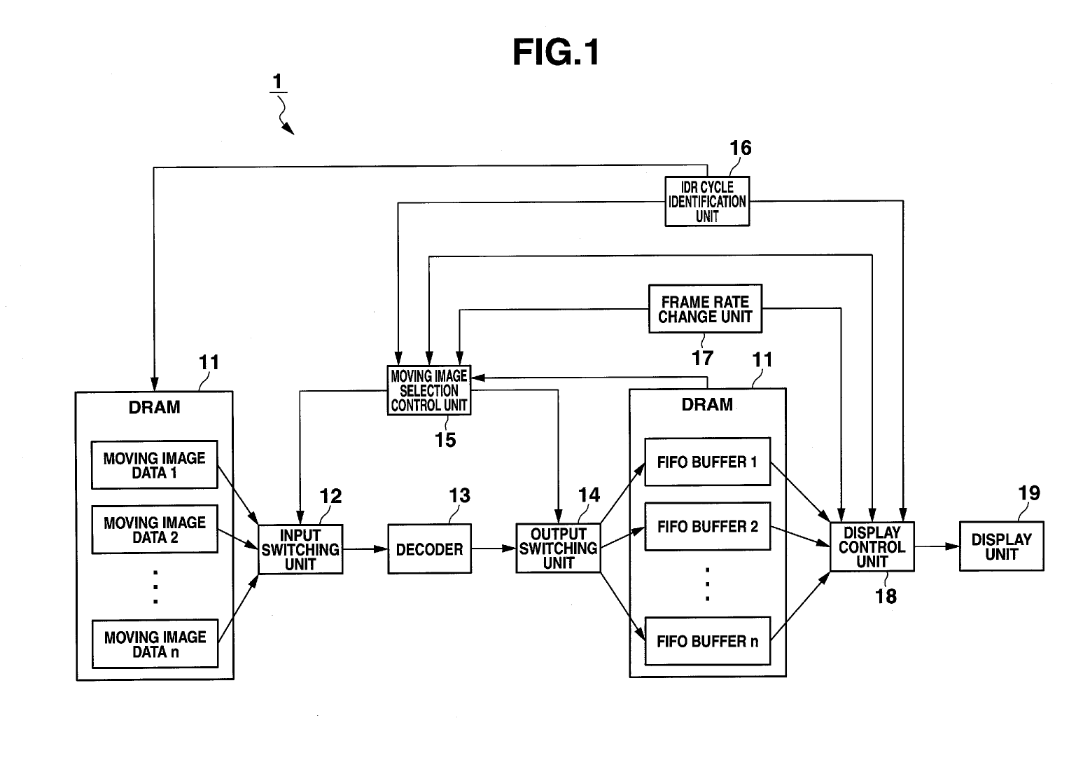

FIG. 1 is a block diagram showing a case of performing decoding processing in a moving image processing apparatus according to an embodiment of the present invention.

“Decoding processing” in the present embodiment refers to a sequence of processing of: decoding by arbitrarily inputting a plurality of moving image data sets stored in a memory unit (DRAM 11, described later) into a single decoder; temporarily storing decoded data in a buffer; outputting the data in a display unit (display unit 19 described later) sequentially in the order of being stored; and splitting a plurality of moving images to display.

It should be noted that moving image data used for decoding is moving image data, of which an IDR cycle and a frame rate differ from each other, in which moving image data captured by a plurality of image capture apparatuses is encoded for storing.

As shown in FIG. 1, the moving image processing apparatus 1 includes DRAM (Dynamic Random Access Memory) 11, an input switching unit 12, a decoder 13, an output switching unit 14, a moving image selection control unit 15, an IDR cycle identification unit 16, a frame rate change unit 17, a display control unit 18, and a display unit 19.

The DRAM 11 is used as buffer memory for temporarily storing image data as well as working memory for various functional units.

Furthermore, the DRAM 11 stores a plurality of moving image data sets 1, 2, . . . n of which an IDR cycle and a frame rate differ from each other.

The plurality of moving image data sets 1, 2, . . . n is arbitrarily selected as a plurality of moving image data sets that is replayed at the same time.

Furthermore, the DRAM 11 includes a FIFO (First In, First Out) buffer area that stores moving image data to be replayed for each moving image data. The data stored in the FIFO buffer area is processed with an operational principle in which data initially inputted into memory is processed first and data subsequently inputted is processed after the processing for the data initially inputted ends.

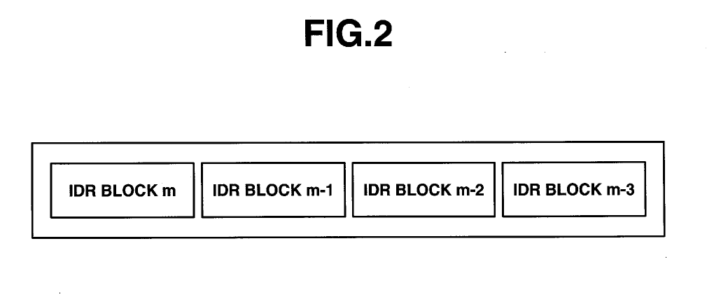

FIG. 2 is a schematic diagram showing a FIFO buffer area.

A FIFO buffer area is secured for each moving image data that is displayed and replayed as shown in FIG. 1.

As shown in FIG. 2, for each FIFO buffer area, an area of an IDR block m, an area of an IDR block m-1, an area of an IDR block m-2, and an area of an IDR block m-3 are secured which correspond to each IDR block.

Furthermore, each FIFO buffer area is secured in consideration of frame rate and processing capacity of codec.

Furthermore, each FIFO buffer area is configured so as to secure at least a storage volume that can store frame images for at least an IDR cycle for each moving image data set.

Furthermore, it is configured in the DRAM 11 so that an IDR cycle identification unit 16 described later identifies an IDR cycle, an IDR cycle of each moving image data designated as a replay/record target is identified prior to replaying/recording and memory capacity corresponding to each moving image data dynamically changes according to the IDR cycle thus identified.

For the FIFO buffer area thus configured, an area is secured for which the IDR cycle is considered based on an analysis result of moving image data.

More specifically, for example, in a case in which the IDR cycle of the moving image data 1 is “N1” and the data size of a unit frame image of the moving image data 1 is “S1” bytes, the memory area of “N1×S1” is secured as a FIFO buffer 1 that stores decoded data of the moving image 1. Furthermore, in a case in which the IDR cycle of the moving image data 2 is “N2” and the data size of a unit frame image of the moving image data 1 is “S2”, the memory area of “N2×S2” is secured as a FIFO buffer 1 that stores decoded data of the moving image 2.

Therefore, in the moving image processing apparatus 1, in a case of employing the moving image data 1 and the moving image data 2 for the decoding processing, the N1 number of the frame images of one IDR cycle of the moving image data 1 is decoded, and then sequentially stored in the FIFO buffer 1. Next, the N2 number of the frame images of one IDR cycle of the moving image data 1 is decoded, and then sequentially stored in the FIFO buffer 2. The respective processing is repeated.

With reference to FIG. 1 again, the input switching unit 12 switches moving image data that is outputted to the decoder from among the moving image data stored in the DRAM 11. The input switching unit 12 performs switching control of inputting moving image data from among a plurality of moving image data sets by the moving image selection control unit 15. By way of the moving image selection control unit 15, the input switching unit 12 inputs a predetermined moving image data set to the decoder 13.

The decoder 13 decodes moving image data outputted from the input switching unit 12 and extracts data before compression.

The decoder 13 outputs the data thus extracted to the output switching unit 14.

The output switching unit 14 causes predetermined FIFO buffers 1, 2, . . . n of the DRAM 11 to store the data extracted by the decoder 13 (hereinafter, referred to as “decoded data”). The output switching unit 14 performs switching control causing a plurality of predetermined FIFO buffers 1, 2, . . . n to store the decoded data by way of the moving image selection control unit 15. By way of the moving image selection control unit 15, the output switching unit 14 causes predetermined FIFO buffers 1, 2, . . . n to store the decoded data.

The moving image selection control unit 15 respectively controls input-switching of moving image data to the decoder 13 from the input switching unit 12 and output-switching of the decoded data to the FIFO buffer of the DRAM 11 from the output switching unit 14 based on an IDR cycle identified by the IDR cycle identification unit 16 and a frame rate of moving image data that is changed by the frame rate change unit.

Furthermore, the moving image selection control unit 15 respectively controls input-switching of moving image data to the decoder 13 from the input switching unit 12 and output-switching of the decoded data to the FIFO buffer of the DRAM 11 from the output switching unit 14, based on a replay time of each moving image data on the display unit 19 according to the display control on the display unit 19 from the display control unit 18.

More specifically, the moving image selection control unit 15, for example, performs control to switch to moving image data having the shortest replay time. In this case, the moving image selection control unit 15 may be configured so as to convert the amount of moving image data that is already inputted to the decoder by a predetermined block unit to the total replay time according to the number of frames constituting the IDR cycle and a frame rate of each moving image data, and then select moving image data to be inputted to the decoder in a unit IDR cycle so as to be equal to the total replay time.

It should be noted that the moving image processing apparatus 1 may be configured so as to calculate the total replay time of a plurality of predetermined blocks that are already inputted to the decoder, according to a frame rate that differs in each IDR cycle and the number of frames constituting each IDR cycle.

Furthermore, the moving image selection control unit 15 respectively controls input-switching of moving image data to the decoder 13 from the input switching unit 12 and output-switching of the decoded data to the FIFO buffer of the DRAM 11 from the output switching unit 14, based on a buffer remaining amount of each FIFO buffer 1, 2, . . . n of the DRAM 11. More specifically, the moving image selection control unit 15, for example, controls to switch from moving image data corresponding to a FIFO buffer of which the buffer remaining amount is low to other moving image data, or controls to switch to moving image data corresponding to a FIFO buffer of which the buffer remaining amount is high.

The IDR cycle identification unit 16 analyzes each moving image data set stored in the DRAM 11 to identify an IDR cycle for each moving image data set. The “IDR cycle” refers to the number of frames that is an insertion interval of IDR frames. In other words, the IDR cycle identification unit 16 identifies an IDR cycle based on an insertion interval of IDR frames by analyzing moving image data.

The frame rate change unit 17 changes from a frame rate of a predetermined moving image data set to a frame rate that is arbitrarily designated by a user by way of a user's operation.

The display control unit 18 controls the display unit 19 so as to output to display decoded data that is stored in a predetermined FIFO buffer area in the DRAM 11.

The display control unit 18 determines a FIFO buffer area in which decoded data to be displayed is stored and controls the display unit 19 so as to display the decoded data stored in the FIFO buffer area thus determined based on an IDR cycle identified by the IDR cycle identification unit 16 and a frame rate of moving image data changed by the frame rate change unit.

The display unit 19 is configured with a display, etc. and displays decoded data stored in predetermined FIFO buffer areas 1, 2, . . . n in the DRAM 11 by way of the control of the display control unit 18.

In the moving image processing apparatus 1 configured as described above, failure does not occur at the time of simultaneously replaying even in a case of having different codec characteristics (frame rate, IDR cycle) in a plurality of moving image data sets.

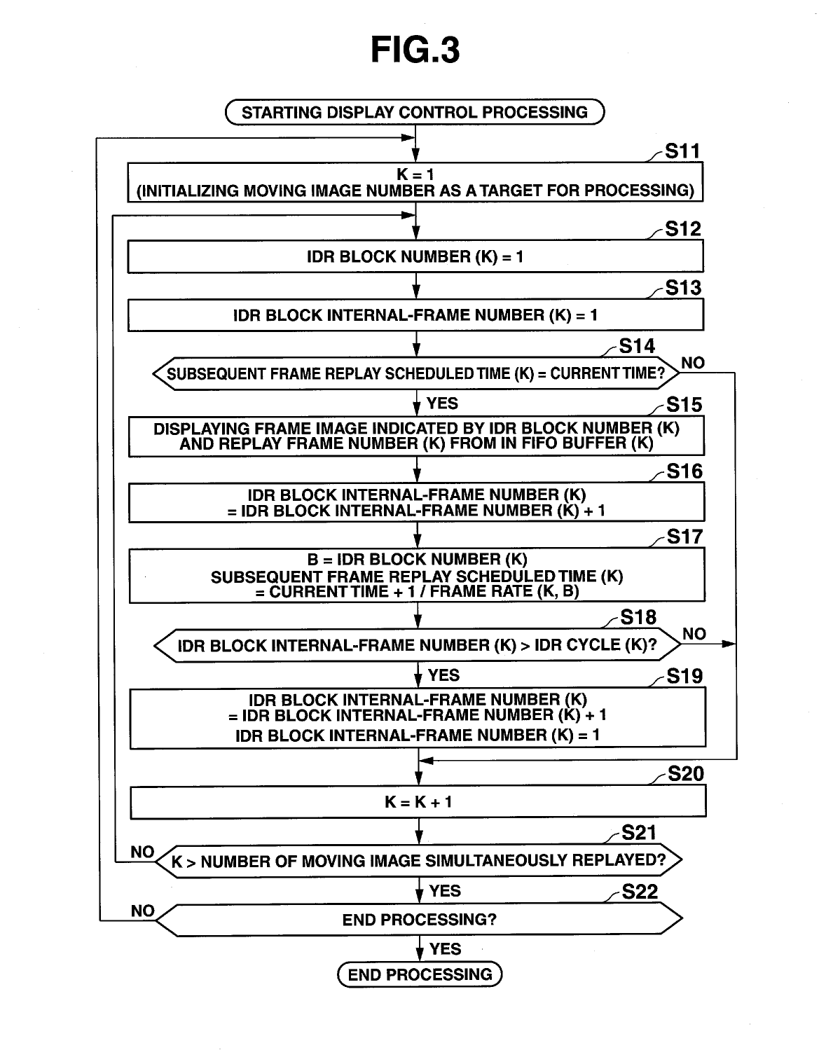

FIG. 3 is a flowchart showing a flow of display control processing executed by the display control unit 18 of FIG. 1.

In the display control processing, when a scheduled time for replay arrives, the display control unit 18 acquires a moving image data set that is already decoded from the FIFO buffer of the DRAM 11 according to a frame rate and replays on the display unit 19, respectively, with a cycle of the frame rate designated. Then, in the display control processing, in a case of becoming the number of moving images simultaneously replayed, the processing ends.

It should be noted that, for moving image data that is already decoded, a frame rate differs for each IDR block of data. In other words, the display control unit 18 controls to replay on the display unit 19 based on a frame rate of each IDR block of the moving image data that is already decoded.

In Step S11, the display control unit 18 initializes the number of a moving image data set (hereinafter, referred to as “moving image number”) as a processing target with “K=1”. It should be note that “K” indicates the respective moving image numbers of moving image data decoded.

In Step S12, the display control unit 18 sets “IDR block number (K)=1”.

In Step S13, the display control unit 18 sets “IDR block internal-frame number (K)=1”.

In Step S14, the display control unit 18 determines whether a subsequent frame replay scheduled time (K) is the current time (“subsequent frame replay scheduled time (K)”=“current time”?). However, in a case of replaying a leading frame of each moving image data set, a subsequent frame replay scheduled time (K) is not set. Therefore, assuming that the leading frame satisfies the determination condition, the replay is immediately performed.

In a case in which the subsequent frame replay scheduled time (K) is not the current time, a NO determination is made in Step S14 and the processing advances to Step S20. The processing of Step S20 and after is described later.

On the other hand, in a case in which the subsequent frame replay scheduled time (K) is the current time, a YES determination is made in Step S14 and the processing advances to Step S15.

In Step S15, the display control unit 18 controls to cause the display unit 19 to output and display a frame image indicated by an IDR block number (K) and a replay frame number (K) within the FIFO buffer (K), on the display unit 19. As a result of this, a frame image indicated by an IDR block number (K) and a replay frame number (K) within the FIFO buffer (K) is outputted to be displayed on the display unit 19.

In Step S16, the display control unit 18 sets “IDR block internal-frame number (K)=IDR internal-block frame number (K)+1” and carries forward the count to a subsequent IDR block internal-frame number (K).

In Step S17, the display control unit 18 sets “B=IDR block number (K)” and sets “subsequent frame replay scheduled time (K)=the current time+1/frame rate (K, B)”.

Here, “K” indicates a moving image number of moving image data respectively decoded and “B” indicates an IDR block number. The “frame rate (K, B)” is two-dimensional array data that is generated or updated to be stored by frame rate change processing (described later) and indicates a frame rate of a predetermined IDR block number of a predetermined moving image data set that is already decoded.

In Step S18, the display control unit 18 determines whether the IDR block internal-frame number is greater than the IDR cycle (K) (“IDR block internal-frame number>IDR cycle (K)”).

In a case in which the IDR block internal-frame number is smaller that the IDR cycle (K), a NO determination is made in Step S18 and the processing advances to Step S20.

On the other hand, in a case in which the IDR block internal-frame number is greater than the IDR cycle (K), a YES determination is made in Step S18 and the processing advances to Step S19.

In Step S19, the display control unit 18 sets “the IDR block number (K)=the IDR block number (K)+1 and the IDR block internal-frame number (K)=1” and carries forward the count to an IDR block internal-frame number (K)=1, which is a subsequent IDR block internal-frame number (K).

In Step S20, the display control unit 18 sets “K=K+1” and carries forward the count.

In Step S21, the display control unit 18 determines whether the number of Ks is greater than the number of moving images that is simultaneously replayed (“K>number of moving images that is simultaneously replayed”?).

In a case in which the number of moving images that is simultaneously replayed is greater than the number of Ks, a NO determination is made in Step S21, and the processing returns back to Step S12 and the processing of Step S12 and after is executed.

On the other hand, in a case in which the number of Ks is greater than the number of moving images that is simultaneously replayed, a YES determination is made in Step S21 and the processing advances to Step S22.

In Step S22, the display control unit 18 determines whether the display control processing ends.

In a case in which the display control processing does not end, a NO determination is made in Step S22, and the processing advances back to Step S11 and the processing of Step S11 and after is executed.

On the other hand, in a case in which the display control processing ends, a YES determination is made in Step S22 and the display control processing ends.

In this way, in the display control processing as described above, the display control unit 18 controls to replay moving image data that has already been decoded that is stored in the FIFO buffer in the DRAM 11 based on a frame rate, on the display unit 19. Then, the display control unit 18 sets a subsequent replay timing based on a frame rate of moving image data that has already been decoded. Furthermore, the display control unit 18 searches moving image data that has already been decoded and can be replayed, and waits until a subsequent replay timing comes. Thereafter, the display control unit 18 performs processing of replaying moving image data that has already been decoded for which the replay timing arrived, and setting a subsequent replay timing.

The flow of the display control processing executed by the display control unit 18 of FIG. 1 is explained above.

Hereinafter, a flow of moving image selection control processing executed by the moving image selection control unit 15 is explained below.

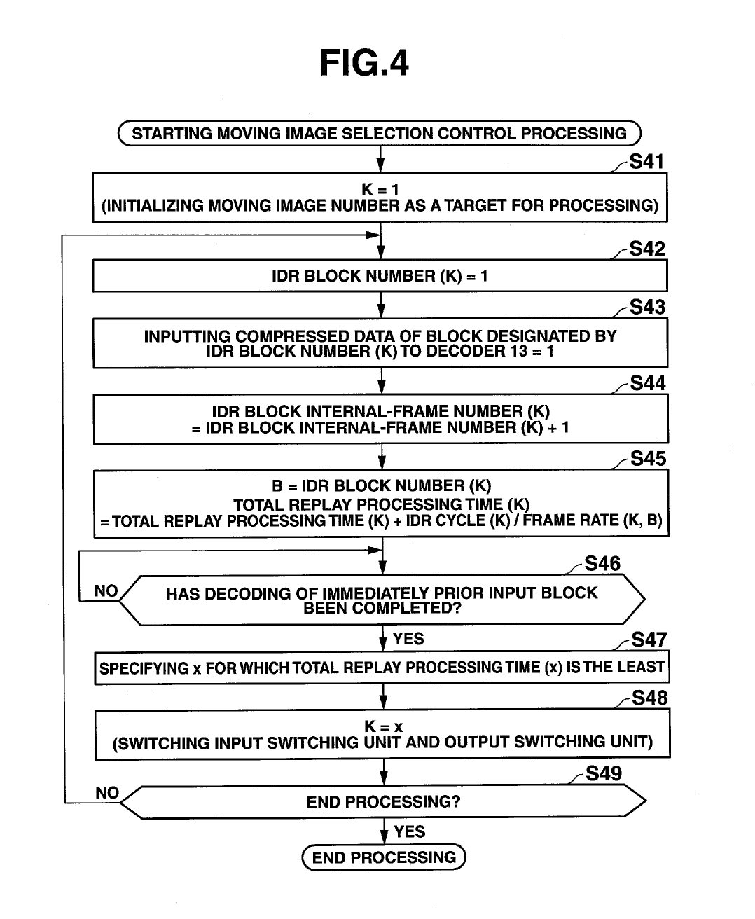

FIG. 4 is a flowchart showing a flow of moving image selection control processing executed by the moving image selection control unit 15 of FIG. 1.

In this moving image selection control processing, the moving image selection control unit 15 performs the selection of moving images based on the total replayed time on the display unit 19 (hereinafter, referred to as “total replay processing time”). More specifically, the moving image selection control unit 15 selects moving image data in which the total replay processing time is the shortest and controls the input switching unit 12 and the output switching unit 14.

In Step S41, the moving image selection control unit 15 initializes the moving image number as a processing target with “K=1”.

In Step S42, the moving image selection control unit 15 sets “IDR block number (K)=1”.

In Step S43, the moving image selection control unit 15 controls the input switching unit 12 so as to input compressed data of a block designated by the IDR block number (K) to the decoder 13. As a result of this, the compressed data of the block in a predetermined moving image set is inputted to the decoder 13 by the input switching unit 12.

In Step S44, the moving image selection control unit 15 sets “IDR block number (K)=IDR block number (K)+1” and carries forward the count to a subsequent IDR block number (K).

In Step S45, the moving image selection control unit 15 sets “B=IDR block number (K) and total replay processing time (K)=total replay processing time (K)+IDR cycle (K)/frame rate (K,B)”.

In Step S46, the moving image selection control unit 15 determines whether decoding of an immediately prior input block has been completed.

In a case in which the decoding of the immediately prior input block has not been completed, a NO determination is made in Step S46 and the moving image selection control unit 15 enters a standby state until the decoding of the immediately prior input block is completed.

On the other hand, in a case in which the decoding of an immediately prior input block has been completed, a YES determination is made in Step S46 and the processing advances to Step S47.

In Step S47, the moving image selection control unit 15 specifies x (among x=1, 2, 3, . . . ) for which the total replay processing time (x) is the least.

In Step S48, the moving image selection control unit 15 sets “K=x” and controls to switch the input switching unit 12 and the output switching unit 14.

In Step S49, the moving image selection control unit 15 determines whether the moving image selection control processing ends.

In a case in which the moving image selection control processing has not ended, a NO determination is made in Step S49 and the processing returns back to Step S42 and the processing of Step S42 and after is performed.

On the other hand, in a case in which the moving image selection control processing has ended, a YES determination is made in Step S49 and the processing ends.

In this way, in the moving image selection control processing as described above, the moving image selection control unit 15 performs processing to control the input switching unit 12 and the output switching unit 14 so as to sequentially select moving image data in which the total replay processing time on the display unit 19 is the shortest from among the moving image data stored in the DRAM 11.

The flow of the moving image selection control processing executed by the moving image selection control unit 15 of FIG. 1 is explained above.

Hereinafter, a flow of frame rate change processing executed by the frame rate change unit 17 of FIG. 1 is explained below.

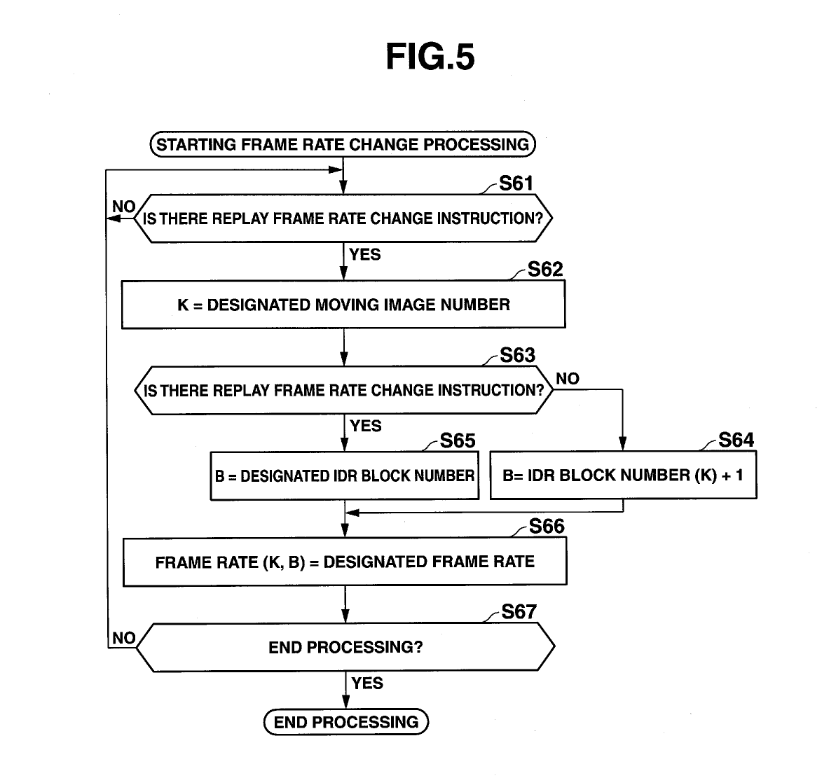

FIG. 5 is a flowchart showing a flow of frame rate change processing executed by the frame rate change unit 17 of FIG. 1.

In this frame rate change processing, the frame rate change unit 17 changes a frame rate of moving image data in IDR block units with an arbitrary timing by a user. Arbitrary timing is variable by an arbitrary timing irrespective of timing such as before replaying moving image data or during replaying moving image data.

In Step S61, the frame rate change unit 17 determines whether there is a change instruction for a replay frame rate from a user.

In a case in which there is not a change instruction of a replay frame rate from a user, a NO determination is made in Step S61 and the frame rate change unit 17 enters a standby state.

On the other hand, in a case in which there is a change instruction for a replay frame rate from a user, a YES determination is made in Step S61 and the processing advances to Step S62.

In Step S62, the frame rate change unit 17 sets “K=designated moving image number” and specifies moving image data to be changed.

In Step S63, the frame rate change unit 17 determines whether there is a designation of an IDR block number from a user.

In a case in which there is not a designation of an IDR block number from a user, a NO determination is made in Step S63 and the processing advances to Step S64.

In Step S64, the frame rate change unit 17 sets “B=IDR block number (K)+1” and carries forward the count from the current IDR block number to a subsequent IDR block number. Thereafter, the processing advances to Step S66. The processing of Step S66 is described later.

On the other hand, in a case in which there is a designation of an IDR block number from a user, a YES determination is made in Step S63 and the processing advances to Step S65.

In Step S65, the frame rate change unit 17 sets “B=designated IDR block number (K)” and advances to the designated IDR block number.

In Step S66, the frame rate change unit 17 sets “frame rate (K,B)=designated frame rate” and stores the frame rate. This frame rate (K,B) is two-dimensional array data.

In Step S67, the frame rate change unit 17 determines whether the frame rate change processing has ended.

In a case in which the frame rate change processing has not ended, a NO determination is made in Step S67 and the processing returns back to Step S61 and the processing of Step S61 and after is performed.

On the other hand, in a case in which the frame rate change processing has ended, a YES determination is made in Step S67 and the frame rate change processing ends.

In this way, in the abovementioned frame rate change processing, the frame rate change unit 17 performs processing of changing a frame rate of moving image data in an IDR block unit from a user. It should be noted that, in a case in which there is not a designation in IDR block units from a user, a frame rate of a subsequent IDR block is automatically changed.

### Modified Embodiment

In the abovementioned moving image selection control processing, the moving image selection control unit 15 is configured so as to switch the input switching unit 12 and the output switching unit 14 with the total replay processing time. However, on the other hand, in the present modified embodiment, the moving image selection control unit 15 is configured so as to switch the input switching unit 12 and the output switching unit 14 based on a remaining amount of a FIFO buffer area.

More specifically, in a case in which a remaining amount of the FIFO buffer area is low, it is configured such that other moving image data is selected and the like, and in a case in which a remaining amount of the FIFO buffer area is high, it is configured such that moving image data for which the remaining amount of the FIFO buffer area is high is selected.

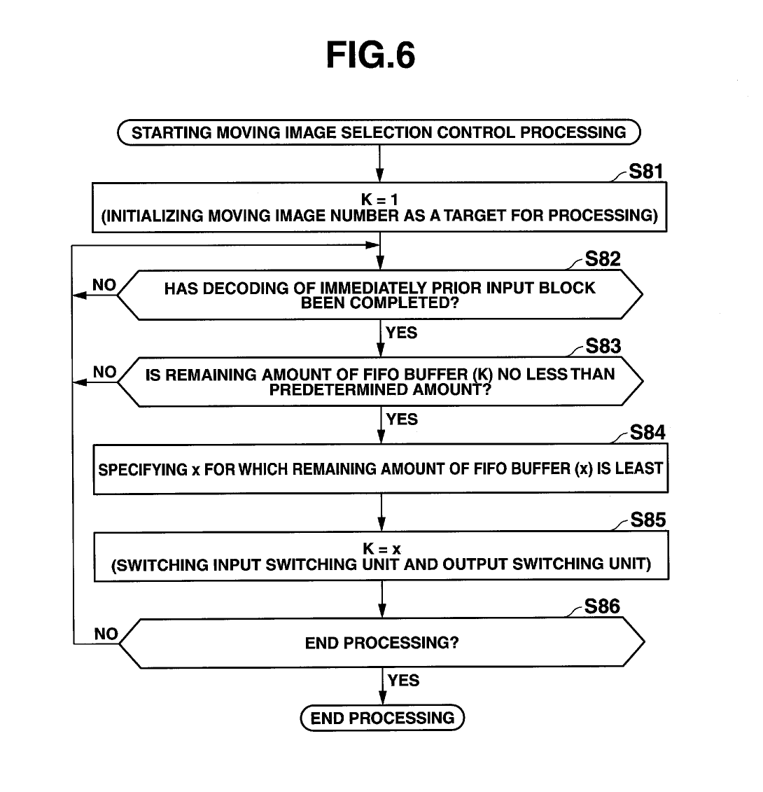

FIG. 6 is a flowchart showing another example of a flow of the moving image selection control processing executed by the moving image selection control unit 15 of FIG. 1.

In Step S81, the moving image selection control unit 15 initializes the moving image number as a processing target with “K=1”.

In Step S82, the moving image selection control unit 15 determines whether decoding of an immediately prior input block has been completed.

In a case in which the decoding of the immediately prior input block has not been completed, a NO determination is made in Step S82 and the moving image selection control unit 15 enters a standby state until the decoding of the immediately prior input block is completed.

On the other hand, in a case in which the decoding of an immediately prior input block has been completed, a YES determination is made in Step S82 and the processing advances to Step S83.

In Step S83, the moving image selection control unit 15 determines whether a remaining amount (K) of a FIFO buffer area is no less than a predetermined amount.

In a case in which the remaining amount (K) of the FIFO buffer area is less than the remaining amount (K) of the FIFO buffer area, a NO determination is made in Step S83 and the processing returns back to Step S82 and the processing after Step S82 is performed.

On the other hand, in a case in which the remaining amount of the FIFO buffer area is no less than a predetermined amount, a YES determination is made in Step S83 and the processing advances to Step S84.

In Step S84, the moving image selection control unit 15 specifies x for which the remaining amount (x) of the FIFO buffer area is the least.

In Step S85, the moving image selection control unit 15 sets “K=x” and controls to switch the input switching unit 12 and the output switching unit 14.

In Step S86, the moving image selection control unit 15 determines whether the moving image selection control processing ends.

In a case in which the moving image selection control processing has not ended, a NO determination is made in Step S86 and the processing returns back to Step S82 and the processing of Step S82 and after is performed.

On the other hand, in a case in which the moving image selection control processing has ended, a YES determination is made in Step S86 and the image selection control processing ends.

The decoding processing of the moving image processing apparatus 1 according to the present embodiment is explained above.

Hereinafter, encoding processing of the moving image processing apparatus 1 according to the present embodiment is explained.

“Encoding processing” in the present embodiment refers to a sequence of processing of: appropriately encoding moving images captured by a plurality of image capture apparatuses by a single encoder; temporarily storing the encoded data in the DRAM 11; and sequentially storing in the storage unit.

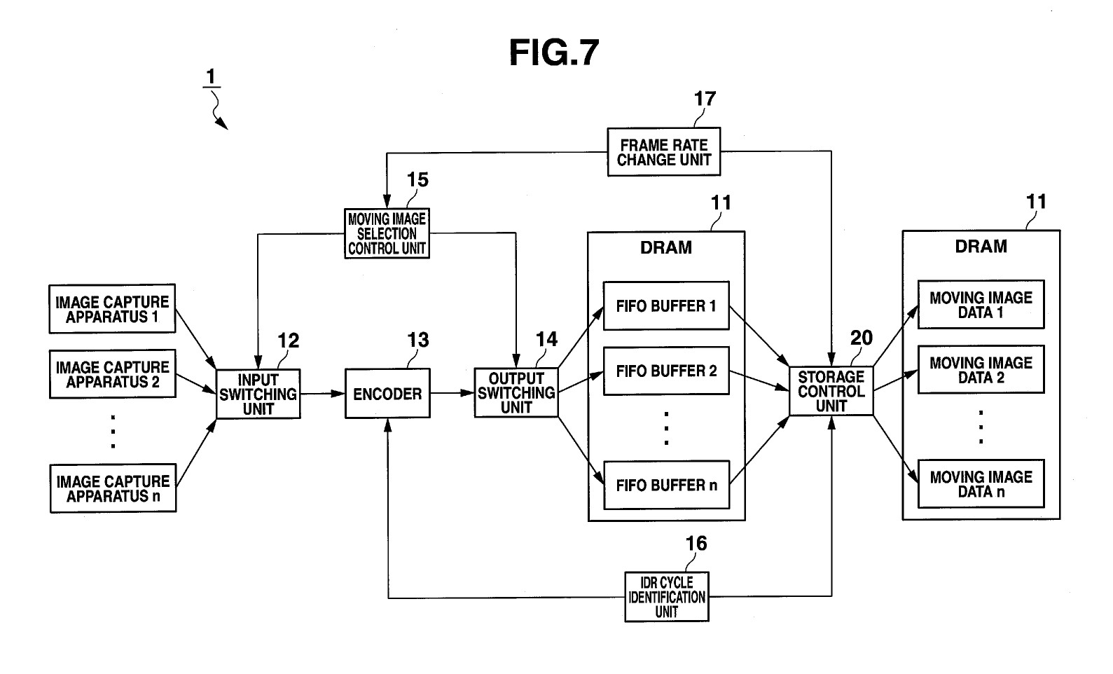

FIG. 7 is a block diagram showing encoding processing in the moving image processing apparatus 1 according to one embodiment of the present invention.

In the moving image processing apparatus 1 according to the present embodiment, a single piece of codec hardware serves as an encoder, in a case of performing encoding processing. In other words, in the moving image processing apparatus 1, the codec hardware that serves as a decoder in the decoding processing serves as an encoder.

It should also be noted that, since the above-mentioned decoding processing has the functional configurations similar to those of encoding processing, the same reference numerals are attached to similar elements and explanations thereof are omitted with reference to the explanations for the decoding processing.

The input switching unit 12 acquires moving image data from the image capture apparatuses 1, 2, . . . n.

The IDR cycle identification unit 16 identifies an IDR cycle for each moving image data set based on an encoded result of the encoder 13.

The storage control unit 20 controls the storage of moving image data in the DRAM 11 by considering: a frame rate change by the frame rate change unit 17; an IDR cycle identified by the IDR cycle identification unit 16, a remaining amount of a FIFO buffer; an input time of data by the input switching unit 12; and the like.

It should be noted that a similar standard as the case of the decoder may be applied for selecting control and storing control of moving images by the moving image selection control unit 15 and the storage control unit 20.

In the moving image processing apparatus 1 configured as described above, failure does not occur at the time of simultaneously recording even in a case of having different codec characteristics in a plurality of moving image data sets.

Furthermore, in the abovementioned moving image processing apparatus 1, it is configured such that the encoding processing and the decoding processing are performed at different timings, i.e. the codec hardware is configured such that the encoding function and the decoding function work at different timings. However, in the moving image processing apparatus 1, it can be configured that the encoding processing and the decoding processing can be performed alternately with an IDR cycle unit of predetermined moving image data, not with the data processing unit working at a different timing.

With such a configuration, in the moving image processing apparatus 1, a single codec hardware resource can be employed in an effective manner.

The moving image processing apparatus 1 as configured above decodes or encodes a plurality of moving image data sets with a single piece of codec hardware having decoder/encoder functions while replaying or recording simultaneously.

The moving image processing apparatus 1 also serves as a simultaneous execution control unit that executes predetermined processing on a plurality of moving image data sets at the same time.

The moving image processing apparatus 1 serves as a plurality of moving image selection units that arbitrarily selects a plurality of moving image data sets that is a target for simultaneous execution by the simultaneous execution control unit.

The codec hardware also serves as a block processing unit that processes moving image data in block units.

The moving image processing apparatus 1 includes the moving image selection control unit 15 and the DRAM 11.

The moving image selection control unit 15 controls the input switching unit 12 and the output switching unit 14 so as to select moving image data to be inputted or outputted from or to the decoder or encoder by switching in order for each predetermined block (IDR frames constituting an IDR cycle).

The input switching unit 12 and the output switching unit 14 also function as a switching unit that switches moving image data processed by the block processing unit in the block unit.

The DRAM 11 temporarily stores already decoded or encoded moving image data to be outputted from the decoder or encoder until it is replayed or recorded.

At least either one of the number of IDR frames constituting an IDR cycle that is a predetermined block and a frame rate that is a speed of replaying or recording differs in each data set among the moving image data sets.

The moving image selection control unit 15 performs determination of a switching timing of moving image data and selection of moving image data to be switched, according to the number of IDR frames constituting an IDR cycle and a frame rate that differ in each moving image data set.

Therefore, in the moving image processing apparatus 1, for a plurality of moving image data sets in which at least either one of the number of IDR frames constituting an IDR cycle that is a predetermined block and a frame rate that is a speed of replaying or recording differs in each data set, the moving image selection control unit 15 performs determination of a switching timing of moving image data according to the number of IDR frames constituting an IDR cycle and a frame rate that differs in each moving image data, and then switches.

The moving image selection control unit 15 also functions as a switching control unit that changes the order of switching a plurality of moving image data sets by the switching unit according to a predetermined state of a plurality of moving image data sets that is a target for switching by the switching unit.

Therefore, in the moving image processing apparatus 1, failure does not occur at the time of simultaneously replaying even in a case of having different codec characteristics in a plurality of moving image data sets.

Furthermore, in the moving image processing apparatus 1, a frame rate that is a speed of replaying or recording is configured so as to be variable during replaying.

The moving image selection control unit 15 further performs determination of a switching timing of moving image data sets and selection of moving image data to be switched, according to a frame rate that is a speed of replaying or recording, which changes during replaying.

Therefore, in the moving image processing apparatus 1, failure does not occur at the time of simultaneously replaying or recording even in a case of a user changing a frame rate during replaying.

Furthermore, a frame rate that is a speed of replaying or recording is configured so as to be variable in IDR cycle units.

Therefore, in the moving image processing apparatus 1, failure does not occur at the time of simultaneously recording or simultaneously replaying, even in a case in which IDR cycles differ from each other with the characteristics of codec differing in a plurality of moving image data sets.

Furthermore, the capacity of the DRAM 11 is configured so as to differ in each moving image data set.

The moving image selection control unit 15 further performs determining a switching timing of moving image data and selecting moving image data to be switched according to the capacity of the DRAM 11 that differs in each moving image data.

Therefore, in the moving image processing apparatus 1, since the memory capacity is determined dynamically according to moving image data sets to be employed, the memory capacity is not unnecessarily consumed for moving image processing.

Furthermore, in the DRAM 11, frame images of at least an IDR cycle are ensured with more than the capacity that can store for each moving image data.

Therefore, in the moving image processing apparatus 1, failure does not occur at the time of simultaneously replaying or simultaneously recording, even in a case in which IDR cycles differ from each other with the characteristics of codec differing in a plurality of moving image data sets.

Furthermore, it is configured in the DRAM 11 so that an IDR cycle of each moving image data set that is designated as a target of replaying or recording is identified prior to replaying or recording and the memory capacity corresponding to each moving image data set is varied dynamically according to the IDR cycle thus identified.

Therefore, in the moving image processing apparatus 1, since processing can be estimated based on the IDR cycle, wasteful memory capacity is not consumed.

Furthermore, the moving image processing apparatus 1 includes the display control unit 18.

The DRAM 11 is buffer memory in FIFO format that is provided for each moving image data set.

The display control unit 18 sequentially reads frame image data sets stored in each FIFO memory and is already decoded with a speed corresponding to a frame rate of each moving image data, and forwards it to the display unit 19.

The moving image selection control unit 15 converts the amount of moving image data that is already inputted to the decoder by a predetermined block unit to the total replay time according to the number of frames constituting the IDR cycle and a frame rate of each moving image data, and then selects moving image data to be inputted to the decoder in a unit IDR cycle so as to be equal to the total replay time.

Therefore, in the moving image processing apparatus 1, failure does not occur since, in the replay processing, in a case in which the characteristics of codec differing in a plurality of moving image data sets are different, the processing of simultaneous replaying is performed with reference to the total replay time.

The moving image selection control unit 15 calculates the total replay time of a plurality of predetermined blocks that are already inputted to the decoder, according to a frame rate that differs in each IDR cycle and the number of frames constituting each IDR cycle.

Therefore, in the moving image processing apparatus 1, failure does not occur in the replay processing since, in a case in which the characteristics of codec differing in a plurality of moving images are different, the processing of simultaneous replaying is performed with reference to the total replay time.

The DRAM 11 is buffer memory in FIFO format that is provided for each moving image data set.

The display control unit 18 and the storage control unit 20 sequentially read frame image data that is stored in the respective FIFO memory and is already decoded or encoded with a frame rate corresponding to a speed of replaying or recording, and then replay or record.

The moving image selection control unit 15 switches to other moving image at a timing at which the data that is decoded or encoded within the FIFO memory corresponding to moving image during decoding or encoding is no less than a predetermined ratio, or a timing at which the data that is decoded or encoded within the FIFO memory corresponding to other moving images not during decoding or encoding is no more than a predetermined ratio.

Therefore, in the moving image processing apparatus 1, failure does not occur at the time of simultaneously replaying or simultaneously recording since, in a case in which the characteristics of codecs differing in a plurality of moving image data sets are different, the capacity of the buffer memory is referred.

Furthermore, in the moving image processing apparatus 1, a single piece of codec hardware (decoder 13•encoder 13) can perform the decoding function and the encoding function in a selective manner, alternately performing decoding and encoding are while alternately switching moving image data set to be replayed and moving image data set to be recorded in IDR cycle units.

Therefore, in the moving image processing apparatus 1, a single piece of codec hardware resource can be employed in an effective manner.

It should be noted that the present invention is not to be limited to the aforementioned embodiment, and that modifications, improvements, etc. within a scope that can achieve the object of the present invention are also included in the present invention.

Although changing a frame rate at the frame rate change unit 17 is configured so as to be performed at a user's arbitrary timing in the abovementioned embodiments, it may be configured so as to be changed prior to starting the processing of simultaneously replaying or the like in advance or to be changed during the processing of simultaneously replaying. It may be configured so that the timing of changing is not necessarily made immediately after a change instruction and, for example, a predetermined IDR block such as a second half of a moving image is designated for the timing.

Furthermore, although the abovementioned embodiments are described as being in conformity with H.264/MPEG-4 AVC, another format can be applied thereto. For example, although the same IDR cycle (N) is used for the input data and the output data, it may be configured that different cycles (N1, N2) are applied thereto. In this case, the IDR cycle is configured so as to perform decoding and encoding with a unit employing the least common multiple for different cycles (N1, N2).

In the aforementioned embodiments, a digital camera has been described as an example of the moving image processing apparatus 1 to which the present invention is applied; however, the present invention is not particularly limited thereto.

For example, the present invention can be applied to any electronic device in general having an encode/decode function. More specifically, for example, the present invention can be applied to a lap-top personal computer, a printer, a television, a video camera, a portable navigation device, a cell phone device, a portable gaming device, and the like.

The processing sequence described above can be executed by hardware, and can also be executed by software.

In other words, the hardware configuration shown in FIG. 1 is merely an illustrative example, and the present invention is not particularly limited thereto. More specifically, the types of functional blocks employed to realize the above-described functions are not particularly limited to the example shown in FIG. 1, so long as the moving image processing apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium etc. distributed separately from the device main body for supplying the program to a user, but also can be constituted by a storage medium or the like supplied to the user in a state incorporated in the device main body in advance. The removable medium etc. is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, in a storage unit etc., in which the program is recorded.

It should be noted that, in the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplification, and do not limit the technical scope of the present invention. Other various embodiments can be employed for the present invention, and various modifications such as omission and replacement are possible without departing from the sprits of the present invention. Such embodiments and modifications are included in the scope of the invention and the summary described in the present specification, and are included in the invention recited in the claims as well as the equivalent scope thereof.

What is claimed is:

1. A moving image processing apparatus comprising:
a block processing unit that processes moving image data in a block unit;
a switching unit that switches the moving image data processed by the block processing unit in the block unit; and
a switching control unit that, according to a predetermined state of a plurality of moving image data sets that is a target for switching by the switching unit, changes an order of switching the plurality of moving image data sets by the switching unit.

2. The moving image processing apparatus according to claim 1, further comprising:
a simultaneous execution control unit that simultaneously executes predetermined processing on a plurality of moving image data sets;
wherein the block processing unit performs preprocessing for the predetermined processing in a block unit; and
the switching unit sets the plurality of moving image data sets that is a target for simultaneous execution by the simultaneous execution control unit as a switching target.

3. The moving image processing apparatus according to claim 2, further comprising:
a plurality of moving images selection unit that arbitrarily selects the plurality of moving image data sets that is a target for simultaneous execution by the simultaneous execution control unit.

4. The moving image processing apparatus according to claim 1, wherein
the switching control unit changes the order of switching the plurality of moving image data sets by the switching unit according to a recording state of a plurality of moving image data sets that is a target for switching by the switching unit.

5. The moving image processing apparatus according to claim 2, wherein
the switching control unit changes the order of switching the plurality of moving image data sets by the switching unit according to an execution state of the predetermined processing on the plurality of moving image data sets that is a target for simultaneous execution by the simultaneous execution control unit.

6. The moving image processing apparatus according to claim 2, wherein
the block processing unit decodes moving image data in a block unit, and
the simultaneous execution control unit simultaneously executes processing of replaying on a plurality of moving image data sets.

7. The moving image processing apparatus according to claim 2, wherein
the block processing unit encodes moving image data in a block unit, and
the simultaneous execution control unit simultaneously executes processing of recording on a plurality of moving image data sets.

8. The moving image processing apparatus according to claim 1, further comprising:
memory that stores a plurality of moving image data sets prior to the block processing unit performing preprocessing; and
buffer memory that temporarily stores moving image data after the block processing unit performs preprocessing, until the predetermined processing is performed, the buffer memory having a plurality of storage areas corresponding to a plurality of moving image data sets,
wherein
the switching unit includes: an input switching unit that switches, in the block unit, a moving image data set that is processed by the block processing unit from among a plurality of moving image data sets stored in the memory; and an output switching unit that switches, in the block unit, areas within the buffer memory that temporarily stores a moving image data set outputted from the block processing unit.

9. The moving image processing apparatus according to claim 8, further comprising:
a display control unit that displays a moving image data set stored in the buffer memory on a display unit.

10. The moving image processing apparatus according to claim 8, further comprising:
a storage control unit that stores a moving image data set stored in the buffer memory in a storage unit.

11. The moving image processing apparatus according to claim 1, wherein
the switching control unit performs determination of a switching timing of switching a plurality of moving image data sets by the switching unit and selection of moving image data sets to be switched at each timing, according to a predetermined state of the plurality of moving image data sets that is a target for switching by the switching unit.

12. The moving image processing apparatus according to claim 1, wherein
a number of frames constituting the block differs in each moving image data set, and
the switching control unit changes the order of switching the plurality of moving image data sets by the switching unit, according to the number of frames constituting the block which differs in each moving image data set.

13. The moving image processing apparatus according to claim 6, wherein
a speed of replaying moving image data sets differs in each moving image data set by way of the simultaneous execution control unit, and
the switching control unit changes the order of switching the plurality of moving image data sets by the switching unit, according to the speed of replaying that differs for each moving image data set.

14. The moving image processing apparatus according to claim 13, wherein
the speed of replaying changes by the block unit during simultaneously replaying the plurality of moving image data sets by way of the simultaneous execution control unit, and
the switching control unit changes the order of switching the plurality of moving image data sets by the switching unit, according to the speed of replaying which changes during simultaneously replaying.

15. The moving image processing apparatus according to claim 7, wherein
a speed of recording moving image data differs in each moving image data set by way of the simultaneous execution control unit, and
the switching control unit changes the order of switching the plurality of moving image data sets by the switching unit, according to the speed of recording that differs in each moving image data set.

16. The moving image processing apparatus according to claim 15, wherein
the speed of replaying changes by the block unit during simultaneously recording of the plurality of moving image data sets by way of the simultaneous execution control unit, and
the switching control unit changes the order of switching the plurality of moving image data sets by the switching unit, according to the speed of recording that changes during simultaneously recording.

17. The moving image processing apparatus according to claim 1, wherein
the block unit defines a block composed of a plurality of frames divided by an IDR frame of a moving image data set as a unit.

18. The moving image processing apparatus according to claim 8, wherein
the capacity of the buffer memory differs in each moving image data set, and
the switching control unit changes the order of switching the plurality of moving image data sets by the switching unit, according to the capacity of the buffer memory that differs in each moving image data set.

19. The moving image processing apparatus according to claim 18, wherein
the buffer memory ensures capacity that can store at least frame images of the IDR cycle for each moving image data set.

20. The moving image processing apparatus according to claim 19, wherein
the moving image processing apparatus identifies an IDR cycle of each moving image data set and dynamically changes the capacity of buffer memory corresponding to each moving image data set according to the IDR cycle identified.

21. A moving image processing apparatus that simultaneously replays a plurality of moving image data sets while decoding the plurality of moving image data sets by a single decoder, comprising:
a control unit that selects a moving image data set inputted or outputted to the decoder while switching the moving image data set for each predetermined block in order; and
buffer memory that temporarily stores a moving image data set that is outputted from the decoder and is already decoded, until replaying the moving image data set that is outputted from the decoder and is already decoded, wherein
at least either one of a number of frames constituting the predetermined block and a speed of the replaying differs in each moving image data set, and
the control unit performs determination of a switching timing of the moving image data set and selection of a moving image data set to be switched, according to the number of frames constituting the predetermined block or the speed of the replaying that differs in each moving image data set.

22. The moving image processing apparatus according to claim 21,
wherein the buffer memory is buffer memory in FIFO format that is provided for each moving image data set,
wherein the moving image processing apparatus further comprises a display control unit that sequentially reads, at a speed corresponding to a frame rate of each moving image data set, and forwards to a display device, frame image data that is stored in respective FIFO memory and is already decoded, and
wherein the control unit converts the amount of moving image data that is already inputted to the decoder in the predetermined block unit to the total replay time according to the number of frames constituting the predetermined block and a speed of replaying each moving image data, and then selects a moving image data set to be inputted to the decoder in the predetermined block unit so as to be equal to the total replay time.

23. The moving image processing apparatus according to claim 22, wherein
the control unit calculates the total replay time of the plurality of predetermined blocks that is already inputted to the decoder, according to a speed of replaying that differs for each predetermined block and a number of frames constituting each predetermined block.

24. The moving image processing apparatus according to claim 21,
wherein the buffer memory is buffer memory in FIFO format that is provided for each moving image data set,
wherein the moving image processing apparatus further comprises a control unit that sequentially reads, at a speed corresponding to a speed of replaying, and replays frame image data sets that are stored in respective FIFO memory and are already decoded, and
wherein the control unit switches to other moving images at a timing at which the data that is already decoded within the FIFO memory corresponding to a moving image during decoding becomes no less than a predetermined ratio, or at a timing at which the data that is already decoded within the FIFO memory corresponding to another moving image not during decoding becomes no more than a predetermined ratio.

25. A moving image processing apparatus that simultaneously records a plurality of moving image data sets while encoding the plurality of moving image data sets by a single encoder, comprising:
a control unit that selects a moving image data set inputted or outputted to the encoder while switching the moving image data set for each predetermined block in order; and
buffer memory that temporarily stores a moving image data set that is outputted from the encoder and is already decoded, until recording the moving image data set that is outputted from the decoder and is already decoded, wherein
at least either one of a number of frames constituting the predetermined block and a speed of recording differs for each moving image data set, and
the control unit performs determination of a switching timing of the moving image data sets and selection of a moving image data set to be switched, according to the number of frames constituting the predetermined block or the speed of recording that differs for each moving image data set.

26. The moving image processing apparatus according to claim 25, wherein
the control unit calculates a total replay time of a plurality of predetermined blocks that is already inputted to the encoder, according to a speed of recording that differs for each predetermined block and a number of frames constituting each predetermined block.

27. The moving image processing apparatus according to claim 25,
wherein the buffer memory is buffer memory in FIFO format that is provided for each moving image data set,
wherein the moving image processing apparatus further comprises a control unit that sequentially reads, at a speed corresponding to a speed of replaying, and records frame image data sets that are stored in respective FIFO memory and are already decoded, and
wherein the control unit switches to other moving images at a timing at which the data that is already encoded within the FIFO memory corresponding to a moving image during decoding becomes no less than a predetermined ratio, or at a timing at which the data that is already encoded within the FIFO memory corresponding to another moving image not during encoding becomes no more than a predetermined ratio.

28. The moving image processing apparatus according to claim 25,
wherein the buffer memory is buffer memory in FIFO format that is provided for each moving image data set,
wherein the moving image processing apparatus further comprises a control unit that sequentially reads, at a speed corresponding to a speed of recording, and records frame image data sets that are stored in respective FIFO memory and are already encoded, and
wherein the control unit switches to another moving image at a timing at which the data that is already encoded within the FIFO memory corresponding to a moving image during encoding becomes no less than a predetermined ratio, or at a timing at which the data that is already encoded within the FIFO memory corresponding to another moving image not during encoding becomes no more than a predetermined ratio.

29. The moving image processing apparatus according to claim 1, wherein
the block processing unit can selectively perform the decoding function and the encoding function, alternately performing decoding and encoding while alternately switching in the predetermined block unit between a moving image data set to be replayed and a moving image data set to be recorded.

30. A moving image processing method of simultaneously performing predetermined processing on a plurality of moving image data sets using a block processing unit that processes moving image data in a block unit; the method comprising:
switching processing of switching the moving image data processed by the block processing unit in the block unit; and
switching control processing of changing, according to a predetermined state of a plurality of moving image data sets that is a target for switching in the switching processing, an order of switching the plurality of moving image data sets in the switching processing.

31. A non-transitory storage medium encoded with a computer-readable program that enables a computer of a moving image processing apparatus of simultaneously performing predetermined processing on a plurality of moving image data sets using a block processing unit that processes moving image data in a block unit; to execute functions as:
a switching unit that switches the moving image data processed by the block processing unit in the block unit; and
a switching control unit that, according to a predetermined state of a plurality of moving image data sets that is a target for switching by the switching unit, changes an order of switching the plurality of moving image data sets by the switching unit.
